(19) United States
(12) Patent Application Publication
(10) Pub. No.: US 2009/0222328 A1
(43) Pub. Date: Sep. 3, 2009

(54) Method of Inducing Communication and Providing Coupons between Businesses and Consumers via a Business and Consumer Management and Resource System

(75) Inventors: Darek Figueroa, Citrus Heights, CA (US); Satheesh Kanchi, Fair Oaks, CA (US)

Correspondence Address: MATHEW J. TEMMERMAN, 423 E STREET, DAVIS, CA, 95616, US

(73) Assignee: Wowzzy Inc.

(21) Appl. No.: 12/396,383

(22) Filed: Mar. 2, 2009

Related U.S. Application Data
(60) Provisional application No. 61/067,546, filed on Feb. 28, 2008.
(60) Provisional application No. 61/125,160, filed on Apr. 23, 2008.
(60) Provisional application No. 61/088,512, filed on Aug. 13, 2008.
(60) Provisional application No. 61/147,877, filed on Jan. 28, 2009.

(51) Int. Cl. G06Q 30/00; G06F 17/30; G06Q 10/00

(52) U.S. Cl. 705/10; 707/9; 707/5; 705/14; 707/E17.059; 707/E17.074; 707/E17.108

(57) ABSTRACT

A network based business and consumer resource system for businesses to open a dialog channel with customers and clients, and for potential customers and clients to open a dialog channel with businesses. A search engine is provided to allow potential customers to locate business profile pages, the search engine dependent upon the sum of points awarded to businesses on the network for performing various business related tasks. The search results may be provided in a format wherein brick and mortar businesses geographically local to the searcher are provided in one dataset while eCommerce search results are provided in another. Further, the present system through link swapping provides a means to increase the ranking of the business profile page on popular public search engines. Finally, a means is provided wherein business owners with large consumer lists can take part in targeted marketing to subsets of the list wherein the marketing occurs at a steady rate so the business minimizes large spikes in responses.

### RELATED APPLICATION

The present application claims priority to provisional application 61/067,546 filed Feb. 28, 2008, provisional application 61/125,160 filed Apr. 23, 2008, provisional application 61/088,512 filed Aug. 13, 2008, and provisional patent application 61/147,877, filed Jan. 28, 2009, all of which are incorporated by reference herein in their entirety as if set out in full.

### FIELD OF THE INVENTION

The present invention relates to data processing, and more specifically to a means for providing business information and facilitating contact between businesses and consumers via a business and consumer resource system.

### GENERAL BACKGROUND

With the rise in popularity of the Internet towards the end of the 20^{th} century and the beginning of the 21^{st} century, the study of social interaction in networks turned a new direction upon which businesses have begun to capitalize. In fact, many new and relatively large business and consumer management and resource systems have recently appeared that now operate primarily over the Internet.

Beginning with services such as Usenet, BBS, Arpanet, and the Electronic Information Exchange Service and progressing to sites such as Classmates.com and FixDegree.com, popular business and consumer management and resource systems sites now operate under such well know names as Facebook.com, MySpace.com and LinkedIn.com. Although the current business and consumer management and resource network systems listed here are relatively recent, the notion that individual computers may be linked electronically to facilitate social interaction was suggested as early as late 1970s.

The above services have shown that the strength of numerous weak ties can be very important for users seeking information and innovation. However, in order to best introduce business opportunities to members in a network, businesses must have effective and efficient means of communicating to their potential consumers.

Further, the members of the network must have an effective and efficient means of locating the best business to meet their current needs. Given the vast expansion of the Internet in the last decade it has become, in some ways, more difficult for a consumer to locate a reputable business. This is particularly true when the consumer requires a business in an industry in which the consumer is not well experienced. Thus, businesses have more than ever taken note to the extent at which online networks can connect them to consumers and expand their contact base substantially—all at a low cost.

Because of this, a burgeoning market of consumers searching businesses has propelled myriad advances in the search engine industry, such that large pools of results in light of a searcher's search request are distilled down to a meaningful list of “hits”. To each individual business, it is in that business's best interests to optimize its position on a search results list.

Finally, and again due to the vast expansion of the Internet and relatedly the vast expansion of potential contact for a business, it is has become difficult for a business to keep in communication with those contacts. Many businesses keep customer lists, and for some businesses these lists can be so long that there is no easy way for the business to contact all of its customers. Most servers which would be responsible for sending the business's electronic mail limit the number of messages that may be sent per day, often without the knowledge of the business owner. The business owner may thus attempt to send a message to 1000 previous customers, only to have the first 200 actually be transmitted by the server.

### DESCRIPTION OF THE PRIOR ART AND OBJECTIVES OF THE INVENTION

Conventionally, businesses have attempted to capitalize on the potential offered above through their integration as nodes into current popular social network programs or through advertisements (often in the form of banners and popup ads) integrated into existing social network programs. Unfortunately, in these social networks, each member, including the business members, are restrained to a position of equal power with every other member. Such restraint is not consistent with the typical market approach and capitalism in general.

Businesses are also able to capitalize on large networks through the global reach of the Internet. The current surge of social networking has made it possible to maintain an ongoing customer list that spans the entire globe. One problem, however, is that oftentimes regional and cultural differences reduce the effectiveness of a single global network. Businesses are lacking an efficient way to categorize and contact specific groups of a potentially worldwide customer base. There is thus a need for regional networks to link users with the appropriate businesses.

Efforts have been expended to provide services for allowing businesses to contact large pools of consumers. Sometimes this means the business owner puts forth the effort of paring down the customer list to only those consumers sharing some common attribute and to whom the business owner wants to target. This can be very time consuming. There is thus a need to provide an organized way to prepare and disseminate messages to potential consumers.

To handle the now billions of pages that are searched when a search engine pulls results for a user off the World Wide Web, search engines have improved over the recent years. While there may be millions or locally thousands of results with keywords matching those entered by the searcher, most search engines will make a determination that certain pages are more relevant, popular, or authoritative than others. Most search engines thus employ a rank method to determine which results should be “ranked” higher than which other results. How this is done varies from one search engine to another, but many utilize factors such as the frequency of updates to the page being searched and more importantly, the number of “links” to the page—that is, how many other web pages have links pointing to the page in question. More links is often correlated with higher relevance and therefore a higher ranking.

There is thus a challenge for business owners having an online business presence. How to increase the ranking of their business page? To meet this challenge, yet another industry has started, but often results will come only after a very high costs, making it nearly impossible for an average business owner to been seen, unless the consumer already knows the business name and searches specifically for it. There is thus a need to facilitate the linking of consumers and businesses in a way that will promote good business practices, discourage bad ones, and give the business page a means for increasing its ranking on public search engines.

It is therefore a first object of the present invention to provide a regional search engine utilizing a novel means for determining relevance so as to provide a consumer with an optimal business to meet their needs.

It is a further object of the present invention to provide for a business owner a means of generating a list of coupons, for sorting a large number of customers into a customer list segment to which one of the coupons selected from the list can be delivered, and a means for batch processing the coupons so that a select number of coupons are sent out to a portion of the list over a select period of time such that over time all coupons are disseminated to the selected group.

It is a still further object of the present invention to increase the network traffic to a business profile page and to a network in general by improving the ranking of the business profile page in a public search engine.

It is a still further object of the present invention to provide a network based business and consumer resource system wherein much of an individual node's success depends on that node's degree of integration and relationship with the network. By promoting and rewarding a high degree of interactivity to the rest of the network, the overall usefulness and level of information on the network tends to increase, and the consumer tends to benefit.

Additional objects and advantages of the present invention will become apparent to the reader and it is intended that these objects and advantages be within the scope of the present invention.

### BRIEF DESCRIPTION OF THE FIGURES

The foregoing aspects and many of the attendant advantages of the invention will become more readily appreciated as the same becomes better understood by reference to the following detailed description, when taken in conjunction with the accompanying drawings, wherein:

FIG. 1 depicts a flowchart that describes processes occurring during a search request made on the Applicant's search engine;

FIG. 2 depicts the high level design flow for the coupon module of the Applicant' invention according to a preferred embodiment of the invention;

FIG. 3 is a diagrammatic image of the processes occurring as a business owner disseminate a coupon to a subset of consumers;

FIG. 4 depicts a consumer work flow diagram detailing steps and logic involved when a consumer views a coupon sent according to a preferred embodiment of the invention;

FIG. 5 is a diagrammatic depiction of a link swapping module according to a first exemplary embodiment of the invention; and

FIG. 6 is a diagrammatic depiction of a link swapping module according to a second exemplary embodiment of the invention.

### SUMMARY OF THE INVENTION

The present invention is a network based business and consumer resource system for businesses to open a dialog channel with customers and clients, and for potential customers and clients to open a dialog channel with businesses. By creating business profile pages on the publicly available system, business owners can perform such tasks as updating business information, scheduling meetings, responding to customer requests for service in an area, creating coupons that are available in any of the areas in which the business owner is subscribed, and improving the business's ranking in popular publicly accessible search engines. This gives the business owner (particularly small business owners in single locations) an improved ability to market to a specific area.

Consumers may register with the system and interact with the business owners to schedule appointments, leave and review comments about the businesses, post requests for services or goods desired, and search for coupons posted by businesses either in their own city or in different cities. Consumers either registered with the present system or unregistered and merely accessing the present system over a network, may utilize a customized search engine to find business profile pages representing both brick and mortar businesses as well as online businesses. In this regard, the system search engine locates keywords from the business profile pages, generates a profile page database from the keywords along with other information about the business, receives a search request from a consumer utilizing the system, and then identifies relevant businesses for the searcher and provides the search results in a format wherein brick and mortar business search results are presented on a first tab, and eCommerce business search results are presented on a second tab.

In an alternative embodiment of the invention, the system uses a novel means of ranking the businesses in the search results, wherein the system receives specific business attributes associated with the business profile pages, uses these attributes to determine a ranking score for each business, and presents to a searcher the search results ranked in order of the ranking scores. The business owner operating the business profile page can earn various amounts of points by undertaking various activities, such as updating the business profile page, adding a photo, commercial or business affiliate to the business profile page and sending coupons from the business profile page. Additionally, the search results are influenced by an average review score of the business profile page, wherein a higher score generally means higher placement in the search results presented to the searcher. In a second alternative embodiment of the invention the businesses are ranked in the search results but eCommerce and brick and mortar businesses are listed separately for the searcher.

For many businesses using business profile pages in the present system, the business profile page will be publicly accessible to popular search engine “crawlers” which typically scan the World Wide Web for web pages so that the web pages can be indexed in the search engine related to the crawler. Because the present system provides a means for linking one business profile page in the system to another business profile page in the system, both business profile pages can increase their ranking in most common search engines. There is no maximum to the number of pages that may be linked. For instance, a first page may be linked to 5 others, and each of the other 5 other profile pages may in turn be linked to all 5 others. Because many popular search engines utilize the number of links directed to a web page as a means of weighting the relevance of the web page in any given search results listings, the means described herein will increase the number of links to each business profile page and thereby increase search results page ranking of the business profile.

Finally, the present system provides a means for businesses to send to large amounts of their consumers a targeted coupon based on attributes of that subset of consumers. From a pool of coupons either made by the business owner through the present system or provided by the present system for the business owner to select, the business owner may choose a coupon to send a target list of the consumers. From a large pool of consumers, the business owner may select a group of consumers sharing a common attribute, and then associate that subgroup with the selected coupon. The business owner may then select a maximum number of coupons to be sent per any given time period, and the system will automatically transmit the coupon at a rate not exceeding the maximum number per time period, thereby enabling the business owner to send out the coupons essentially at a steady rate so as not to receive spikes in the number of consumer responses over time.

These and other details of the present invention will become apparent to the reader after the detailed description portion of this patent application.

### DETAILED DESCRIPTION OF THE INVENTION

The present invention is a network based business and consumer resource system through which businesses may contact customers and clients, and through which potential customers and clients may contact businesses. The network is generally accessible over the Internet, and preferably uses the HTTP (standard internet protocol) over the World Wide Web. By accessing the network, business owners can perform various tasks, including but not being limited to updating business information, scheduling meetings, preparing and disseminating consumer-targeted coupons, and responding to user requests. Users of the network who register as consumers may interact with the businesses to schedule appointments, bookmark a business and leave and review comments about the businesses. Businesses, consumers, and non-registered users have access to a specialized search engine that both facilitates the linking of businesses to consumers and promotes the use of the network by businesses.

A network comprises nodes tied together through a plurality of specific types of interdependencies. Nodes in this case are the actors within the networks, i.e. the businesses and consumers interacting on the network as either business users, consumer users, or unregistered users, as described below. Interdependencies in this case may include factors such as area of service, price, customer review, industry category, business name, communication between consumers and/or businesses and distances between geographic locations of the various users. The Applicant's system uses some of these interdependencies and others as a means for determining a business profile page's ranking in a list provided as a result of a search by a searcher on a search engine provided by the Applicant.

For purposes of this application, the term “user” shall refer to any person or business utilizing the Applicant's system. This may include individuals, businesses, government entities or even other computers (such as bots) assigned with the task of using the network. Such users generally access the network from a remote computer over the World Wide Web, using a PC, or may access it through any other means such as over a mobile phone network, LAN, or the like. Although users are not required to sign up with the Applicant's system, those who do are categorized into either consumer users or business users. There are administrator accounts as well which give the network operators the administrative rights needed to ensure smooth operation of the network for the business users and consumer users. The site administrator essentially has access to control many functions of the Applicant's system to meet goals such as fair business practice and site stability, as described below. Those who do not sign up with the Applicant's system as one of the above are referred to as non-registered users.

All users, including non-registered users, may browse the public portions of the Applicant's network. All may also use the Applicant's specialized search engine as a means to search the Applicant's network as described later in this application. Those who sign up with the network as “consumer users” are granted expanded functionality as will be described below. Those who sign up with the network as a “business users” have added functionality not available to consumers, as will be explained below. Consumers and businesses may be referred to collectively as “participating nodes” or “registered users” within the network.

Most online resources operate under an online advertising business model, wherein the more users of the resources, the larger the amount of money to be gained from online advertising. Unlike these current networks, the present system will begin with a large number of nonparticipating nodes (i.e. businesses pulled from public directories). Thus, from the very beginning search results will be expansive, providing great utility for the searcher. At any time a nonparticipating business may register with the Applicant's network and become a business user. With this change in status the business is more than a passive listing, but instead is an active participant in the network and gains all of the aforementioned benefits associated with it.

Referring first to a user who joins the Applicant's system as a business user, the user creates a business owner profile (hereinafter “business profile”) so as to become a participating node in the system. Portions of the business profile termed here a business profile page are publicly accessible. Other portions of the business profile are not publicly accessible and are used for housecleaning, updates, and other administrative tasks by the business user.

In a preferred embodiment of the invention, the business user selects five cities in which that business profile page would appear in search results geographically restricted to near said cities. This approach supports small businesses by giving the business user (particularly the small business owners in a single location) the ability to market themselves to a specific area and not be impeded by other businesses out of the area. This approach also more precisely limits the results of a business search query by a user in another area to results comprising businesses that are in the area searched. For businesses existing in multiple areas, the business owner may optionally be granted additional listings in additional cities. E-businesses oriented toward meeting customers online rather than at a traditional brick and mortar address will also appear in the specialized search results, as described below. Such eCommerce business profiles will not be given the geographic selection option and instead will exist on the network as a network-wide business.

In creating a business owner profile page, the business owner can also create a simple profile by selecting from predefined profile templates and color combinations. Additional changes can be made once the template is in place via a customized toolbox is provided to allow the business user to access functions that modify the various elements of the business profile, such as industry type and description, business logo, location, email address, phone numbers, images, audio and video, commercials, links to other affiliate profiles or other business, calendars, tips of the week and so forth.

For business owners, all of these features plus others not listed here are placed on a single page that will hereinafter be referred to as a dashboard. Other features are available on the dashboard as well, such as consumer statistics for the business user to view, useful links (such as to government business help sites) for the business user and the like. All registered users have a dashboard but the specific items present on each dashboard are dependent on the type of account. For instance, a business user's account has features not present in a consumer's dashboard, and vice versa.

Business users may update the business profile as needed, schedule meetings, add business affiliates, update and view a contact management system (i.e. a built in customer relationship management program), add discounts and coupons, participate in discussions and messaging with consumers, add a detailed description of their business and respond to consumer requests for service. Templates are provided for many of these features as is well known in the art. As will be discussed infra, there are incentives for the business owner to access and update the business owner profile on a regular basis. To update a business profile page, a business owner logs into the system and goes to the dashboard screen. From here, various items may be updated, including a media center, affiliates (including hyperlinks), business duration (how long in business), the type of entity of the business, the number of employees, local memberships the business belongs to, the mission statement for the business, the core values of the business, a business description, and description of the products/services offered.

Business user profiles will optionally contain a link that a user may use to refer a friend to the business owner profile. Through this feature, when one user finds a business profile and wants to refer the profile to a friend, the user simply selects the link on the business owner profile, at which time the Applicant's system prompts the user to send a message to the friend. If the user is a registered user, the Applicant's system will prompt the user to send the message through the system's internal messaging system, and if the user is an unregistered user, the system will preferably send an email to an email address entered by the unregistered user. The message will contain information regarding how to find the business profile page on the network.

The business user profile page also has a means for adding an “affiliate” to the business profile, which essentially links the business profile page to another business profile page on the Applicant's system. Business users add affiliates by “requesting” the affiliate to add them. Once the business user who is the target of the “request” agrees to the affiliation, both business users will then have links to the other business on their public business profile page. As described in detail below, if the business user invites a user who is not registered with the Applicant's system, the user may register as a business user before accepting the invitation.

A business user has the option to accept or not accept the invention from another business user. The request message, as well as all messages sent through the Applicant's system may be delivered through an internal message delivery service within the applicant's system itself, or the message may be delivered through email or another messaging system. When the intended recipient is not already a registered user of the Applicant's system, the preferred method of delivery is via email. If a recipient chooses to accept the invitation by selecting the ‘accept’ option, then the system validates whether the user is a registered business user. If the recipient is not already a registered user, the user is redirected to the registration page where they may accept the invitation upon completion of registration. If the user is a registered business owner, then the associate is added to the profile. All affiliates appear in the business owner's dashboard and optionally on a publicly accessible profile page, along with all the affiliates logos, a brief description of each company and link to each company website, thereby providing a quick list of commonly accessed businesses for a business owner.

In addition to providing added exposure for potential consumers visiting affiliate sites, the affiliate system described herein has one other enormous benefit for the businesses users utilizing it. The links to affiliates from one business profile page to another are optionally publicly accessible and thus provide pathways for search engine crawlers that may be visiting the business profile page. Essentially, keyword swapping and link swapping is disclosed. Through this means, keywords on a first profile page are accessible by a crawler on a second profile page, and likewise, keywords on a second profile page are accessible by a crawler on a first profile page. The information submitted in the “crawler file” thus not only includes the information from the primary site (one where changes took place) but also the links that are associated with that site. Thereby offering the submission of the associated linked site as well. Creating numerous link swaps offers the opportunity for linked profiles to have data about the site presented to the crawlers. In the alternative embodiment of the invention where consumer users have publicly available pages, the links on these profile pages may be swapped similarly to those of two business profile pages.

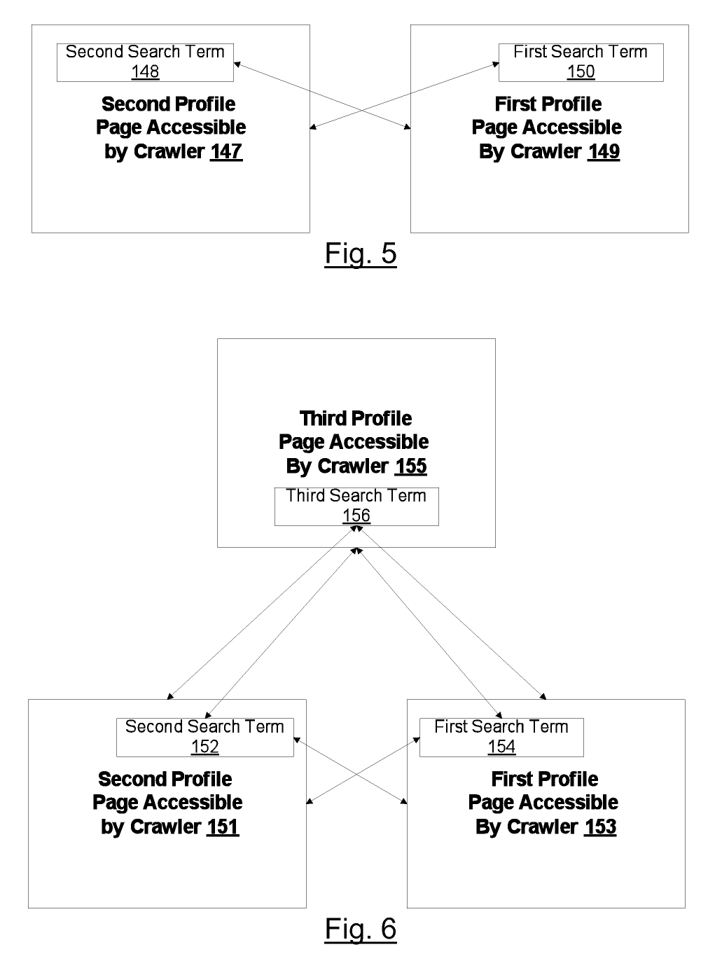

Turning now to FIG. 5, a simple diagram showing a simple two user link swap is seen. Here, a first profile page 149 comprising a first search term 150 is accessible by a crawler accessing a second profile page 147. Likewise, a second search term 148 on said second profile page 147 is accessible to a crawler while the crawler is on a said first profile page 149. Similarly but slightly more complex, FIG. 6 shows a first search term 154 on a first profile page 153 being accessible to a crawler on a second profile page 151 and a third profile page 155. Likewise, second search term 152 is accessible while a crawler is on said first profile page 153 and third profile page 155, and a third search term 156 is accessible while a crawler is on said first profile page 153 and said second profile page 151.

Although the above scenario has been described with two and then three paged participating in the keyword and link swapping, additional pages could be used with no theoretical maximum number used. In an alternative embodiment of the invention, the keywords from a second profile page as well as a link to the second profile page is located in a subdirectory of the folder containing the first profile page. Finally, to further generate page profile views for business users, the present system has a means for automatically placing relevant links and information regarding business profiles into unique websites on the World Wide Web, such that they are indexed by sites such as Google, Yahoo, MSN and the like.

The system also provides a means through which the business user can post product and service discounts on the business profile page, as well as have administrative rights to forums on a page if forums on the page are activated by the business user. Regarding the services discounts, one such discount is in the form of a coupon, as described later in this application. Finally, statistics on unique visitors to the business owner profile page are also available for review by the business owner.

The business user also has the ability to create a web log (hereinafter referred to by its portmanteau, “blog”) available on the business user profile page on the network. Generally blogs are displayed in reverse chronological order and may include news, commentary, updates regarding the company or individual and interactive components. Discussion groups, or forums, are applications for holding discussions and for users to post user generated content. Also referred to as message boards and discussion boards, these provide locations for users to post, review and respond to messages in either a chronological or threaded fashion.

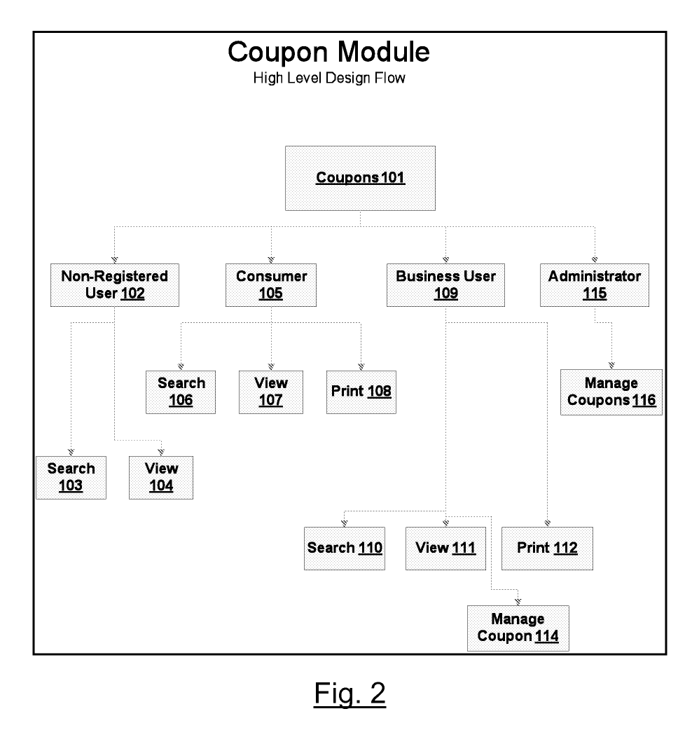

Turning now to FIG. 2, the coupon system is described in detail. The coupon system is essentially a means for delivering a multimedia message 101 to another user of the system or to any other electronic address existing outside of the Applicant' system. While email is certainly one means of delivery, the invention is not to be limited by the type of message sent. Indeed, text messages, video messages, multimedia messages, video emails, links to streaming videos as well as other means of communicating to a consumer are envisioned. The multimedia message 101 (hereinafter referred to as a “coupon”) takes the form of an add-on module for business owners and can be sent to non-registered users 102, consumers 105, other business users 109 and site administrators 115. Non-Registered users 102 can search 103 and view 104 coupons on the Applicant's system. Consumers 105 can search 106, view 107 and print 108 coupons, business users 109 can search 110, view, 111, print 112, and manage coupons 114, while Administrators 115 can globally manage coupons and coupon templates on the system 116.

The business user can use a coupon creation module optimally provided to them by the system as a business user. Pre-made coupons may alternatively be utilized as they are needed (an ala cart feature) directly from the dashboard. The business user can create and distribute coupons and mailers directly from the dashboard. The business user can build the coupon or mailer by using a service provided by a virtual coupon generation system within the network. Each business will have the option of defining their business details, coupon description, bar code, logo and at least one image. In one embodiment business owners can publish a maximum of three coupons at any given time. The business user decides to what cities they wish to market to, and can customize their coupons for different cities. The business user also has the option to view the published coupon as it would be viewed by any other user once received.

To make a coupon in a preferred embodiment of the invention, the business user enters the dashboard, clicks on a coupons link, and from there the system provides the user with a coupon management page. A new coupon may be created here or optionally old coupons previously created may be deleted or accessed. When a business user deletes a coupon, the system prompts the user to answer whether details regarding the coupon should be saved before the coupon is deleted. When managing or creating coupons, there are various qualities of the coupon that may be changed, such as business logo, business image, promotion name, description of the coupon, expiration date for the coupon, placement and configuration of a barcode to recognize the coupon, and a maximum view/print count for the coupon per customer. Other means of multimedia messages are envisioned that could draw business for a business user such a video message that details a discount that may be available, SSM messaging coupons, coupon prepared via email and the like. Various means of messaging are well known in the art and for conciseness reasons will not be discussed here in any further detail.

Once completed, in a preferred embodiment the coupon is uploaded directly onto the business user's dashboard for future use. Once the multimedia message has been built, the business user decides to which cities and to which consumers the coupon should be targeted. It should be noted here that the coupon is not being sent directly to a consumer, but rather the computer used by the consumer, and from there to the consumer. For purposes of conciseness in this application, this application may refer to a coupon being transmitted to a consumer, and this means nothing more than transmission to a remote computer where it may be viewed/understood/printed by a potential customer/consumer of the products and/or services purveyed by the business.

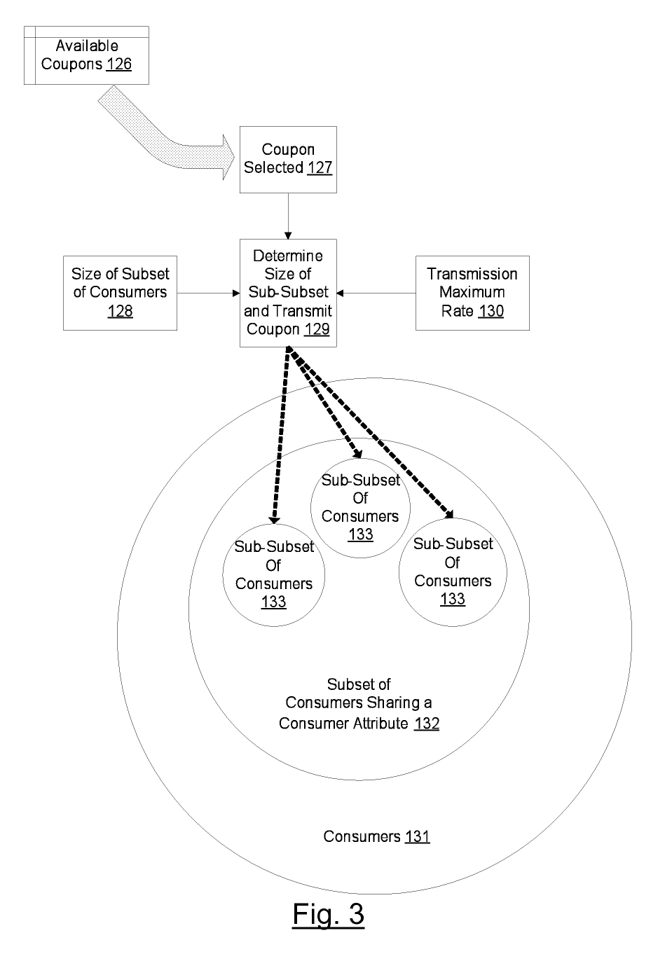

Turning now to FIG. 3, from the list of available coupons 126 to the business user, the business user in this exemplary case selects a coupon 127 for sending. The available coupons 126 may be coupons that the user previously made and had stored, or may be coupons provided for by the Applicant's system either to be customized or to be used as-is. Regardless, the business user selects a coupon that will match the needs a subset of consumers 132 that the business owner desires to contact. The subset of consumers 132 is selected from a larger group of all consumers 131.

In a preferred embodiment, the applicant's system manages the batch processing of transmission of multiple copies of the coupon. For instance, once the business owner has grouped a subset of consumers 132 and associated a coupon therewith, the system, taking the number of consumers in the subset 128 and the highest number of messages that can be delivered over a certain time window, determines 129 the size of the batches of copies of coupons that will be sent to sub-subsets of consumers 133. For instance, if the system allows a maximum of 200 coupons to be sent per day, then sub-subsets of 200 consumers will be used until all in the subset of consumers 132 have been sent a coupon. If for instance, 10 text messages may be sent per day on a particular system, then determining step 129 will determine that the sub-subset of consumer 133 would be of the size ten. The system also allows input for a “start date” upon which the coupons will begin being transmitted to the sub-subgroups.

Alternatively, a transmission maximum rate 130 may be received by the system from the business user. This is a preset maximum number chosen by the business user based on expected responses to the coupons. For instance, if the business user has 1000 customers and would like to spread the coupon to these customers such that no more than 100 per day are transmitted, then the user enters the transmission maximum rate 130 in this instance at one hundred per day. When a transmission maximum rate 130 is entered, the system will create batches of sub-subsets of consumers 133 of a size such that no more coupons will be transmitted in any given timeframe than would be permitted by the transmission maximum rate 130. Although a rate in transmissions per day has been described, other rates would be equally possible, such as one coupon per minute or 500 coupons per week.

If the target recipient of the coupon in the above-described transmission means is a registered user of the Applicant's system, details regarding the delivery means and contact information of the consumer is known. In this instance, information may be automatically gathered by the Applicant's system so that when the business user sends the coupon it will be delivered to the consumer user in a means specified in the consumer user's profile.

Coupons will be sent to consumers in their target area to view as they choose. In a preferred embodiment, the coupons are strictly published and are available only in the cities that the business user has selected to be associated with his or her business profile. Business users decide how long to run their coupons and the expiration date of the coupons. When the coupon is sent to a registered user of the Applicant's system, the user logs in to his or her account, and if the account is linked with the city of choice by the business user or if the user was otherwise targeted by the business user, the target user will see the coupon, which automatically appears on the user's dashboard. In an alternative embodiment of the invention, the dashboard will contain an area that has all available coupons organized by subject matter. For instance, if the user desires pizza, the user can filter all coupons received for the word “pizza”. Through this system, the business owner is allowed a wide distribution without the intrusion (and cost) normally associated with it. More specifically targeted coupons are available as well, such as coupons that only target groups by age, sex, hobby etc.

When a consumer user wants to search/view/print local coupons, the consumer may do so searching by state, city, or by industry. In an alternative embodiment of the invention the user may select both geographically and by industry. The user can then view the relevant coupons, print the coupons, or click the logo on the coupon to go to the coupon owner's profile page.

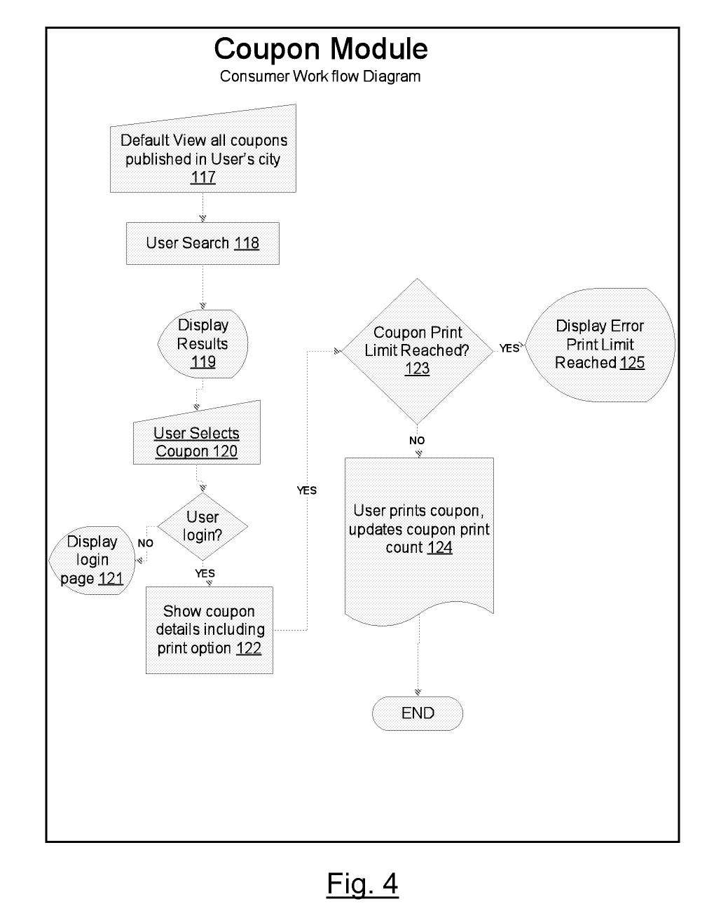

As a default view, all coupons published in the user city 117 are displayed. See FIG. 4. From here, the user may refine the search 118 by geography, by industry, or by both. The results are transmitted 119 to the user. From here the user may select a coupon 120. In the embodiment shown here, if the user is not logged in or if the user is an unregistered user, the coupon will not be displayed but instead the system will display the login page 121 where the user is prompted to create an account. If the user is a registered user, then the coupon details are shown 122. In the embodiment shown here, a limit is set for the number of times the user may view/print the coupon. Thus, a check 123 is made to determine if the coupon print limit is reached. It should be noted that it is not currently possible to prevent a user from printing a coupon multiple times upon one viewing, so it is assumed for purposes of this application that the user is only printing the coupon once for each view. If the user has reached the print limit, the an error 125 is displayed, and if the user has not yet reached the limit, then the coupon is viewed where it may be printed and the print count is updated 124.

Optionally, a preview of the coupon will appear in a pop-up window as the user “hovers” over it with his or her mouse, from which the user may print the image of the coupon. In a further embodiment of the invention and in the embodiment described in the previous paragraph, the system will only allow the viewing and printing of coupon from users registered with the system.

Another means by which a user can view a coupon is directly from a business profile page, if the coupon has been posted there. In this embodiment, a link to the coupon may exist on a preview screen for the coupon or may exist in a separate tab on the business profile page. In either case, the user may view and print the coupon as described above. Optionally, the above limitations regarding view and print limits apply here as well. In addition to obtaining a coupon automatically through the consumer's dashboard, the consumer has the option of searching in different cities as needed to look for the coupons published by the business owner in those cities, either by business owner name or by industry type.

The Applicant's system monitors how many consumers are viewing and printing coupons and the business user may be given access to this information and statistics regarding it. When the consumer prints this coupon, the consumer information will be posted as coupon usage details to the business user. This information can be broken down by city marketed to so the business owner can determine the number of views and prints for each city. Other filters may be applied as well.

In addition to coupons, users of the Applicant's system may also utilize an interactive calendar. For instance, a business user can choose to have a publicly displayed calendar, in which case the system will place a calendar on the business user's profile page through which other participating nodes (users) may schedule appointments. The business user has the option of blocking off repeating periodic times during which there are no availabilities, such as during lunch and night time hours. Additionally, the business user can set a limit as to the number of users that may simultaneously be assigned to any given time slot on the calendar. There is no limit on how many registered users can book an appointment for any given time slot. Once a registered user books an appointment the business user is notified within their dashboard. New appointments will display the appointment. At that time the business user will be prompted to accept the appointment or respond back. If the business user accepts the appointment, this will trigger the consumer's calendar to take the booked appointment and turn it from a tentative appointment to an accepted appointment. While consumer users cannot edit the entries of other registered users, they can remove their own entry from the business calendar should their plans change and they wish to free up a time slot for other registered users. Businesses users can remove the entries as necessary.

As an example of the above, if the business user is a chiropractor on the network and has enabled the public calendar but all appointments are full, if the chiropractor has a cancellation by phone, the chiropractor may log in to the system under her business user account and delete the entry from the business profile calendar. A consumer user searching for a chiropractor who is available at that time of the cancellation may see the opening on the calendar on the chiropractor's business profile. The consumer user may then schedule an appointment at the time the chiropractor has available. Once the scheduling is made, that time slot on the calendar would then appear booked to other users. In a preferred embodiment of the invention, non-registered users cannot manipulate the calendar. In an alternative embodiment of the invention, the business must approve all changes to the calendar before they take effect. In this alternative embodiment, unregistered users may manipulate the calendar but only after the business user approves the change.

Preferably, the business user who is managing the business profile will link the public calendar available through the network with the business user's own internal calendar of the business—even if the internal calendar is completely unrelated to the Applicant's system. Various means of syncing calendars are currently available and well known, any of which may be suitable for this purpose of syncing one calendar to another. For instance, if the business user were closing his store for a week for renovation, the business user would update that business's internal calendar with this information. Preferably, this information would be synced with the online calendar on the Applicant's system so that consumers wishing to schedule a time would see that the week is unavailable, and the business owner had to do no more than update his own business's internal calendar.

Other elements relating to a business user profile will not be editable by the business user. Profile reviews would be one such element. Profile reviews may be left by consumer users about a business profile page. Any review will preferably include a review ID, the ID of the reviewer, the reviewer name, the review itself, a review rating, and an overall rating. The review rating is a numerical rating of the business overall. The overall rating is an average rating based on all review rating scores. In a preferred embodiment of the invention, the overall rating is scaled to a maximum of 5 points.

Users that have registered as consumer users will have a dashboard similar to that of the business user's. The consumer user's dashboard will not be public. In an alternative embodiment of the invention, the consumer will optionally be able to create a public profile similar to the business profile page. Consumers may interact with business users on the network through among other means sending and receiving messages, scheduling appointments with and accessing the calendar for the business, adding businesses to a “favorites” list on the consumer user's dashboard, writing reviews and rating businesses and reading the reviews and ratings from other consumer users, recommending businesses to a friend, searching forums, and managing their messages and forum postings. The dashboard has summary information regarding appointments upcoming, messages received, and so on. On the consumer user's dashboard, the user may save a plurality of businesses in that consumer's “favorite” list of businesses. The favorites list potentially reduces the work required by a consumer to locate a business that the consumer has used in the past.

All users of the system, whether registered or not, may become searchers when they utilize the search engine provided by the Applicant's system. Although much of the content of the Applicant's network is available to 3^{rd} party search engines not related to the Applicant, the Applicant's network also provides its own search engine.

When using the search engine, users are presented with results based on the user's query and a number of other factors. On the user side, there are various means for searching presented. For instance, a simple search receives input data from the user regarding any combination of the business name, business address or industry category. An advanced search is capable of receiving additional data such as user location (for calculating results based partially on distance between user and business location), discount coupon code, and freeform text describing the service or goods. A map related search will work similarly to other map searches conventionally used in the art in that the user's results will be scattered on a map, however, they will utilize the same novel ranking system on the back end. For instance, if the user navigates the map to an area in which the user would like to search, the network will determine the top listings to show on the map, and will identify them with a number just as in the basic and advanced searches, wherein a higher number indicates a higher ranked search result.

The Applicant's system is built to encourage participation by the business user. This is particularly important in growing a network because it is the interaction between nodes in a network that has the largest effect in making the network successful. Indeed, making many modifications to the business profile page can earn ranking points that will later be used to determine that business's ranking in a search conducted of the Applicant's system. In this way the business user is “rewarded” for using the network more.

The search results include both nonparticipating businesses (those businesses that have not signed up with the network but are listed in a public directory) and participating businesses (those businesses that signed up with the network). To encourage businesses to sign up with the network, participating businesses will always be ranked higher in search results than nonparticipating businesses. In a preferred embodiment, the search function is described only with regard to participating notes, i.e. business users, however, in an alternative embodiment, nonparticipating businesses may be incorporated into the search results as well.

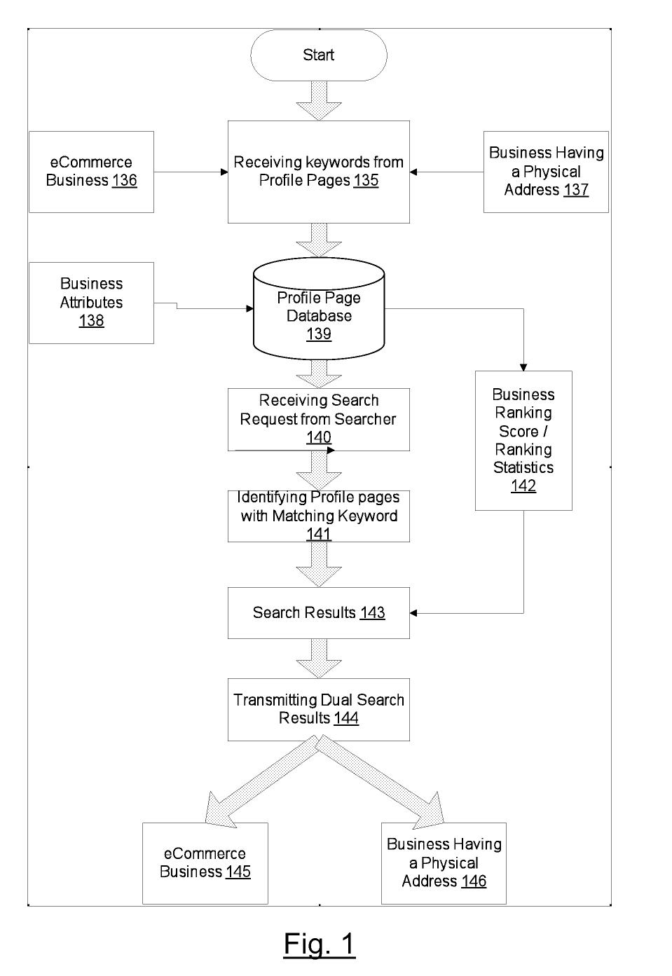

Tuning now to FIG. 1, in the preferred embodiment, a server receives one or more keywords from the business profile page 135. These keywords may be associated with profiles that represent businesses having a physical address 137 or from eCommerce businesses 136, or both. Utilizing these keywords a profile page database 139 is created that includes the keyword terms, the address of the physical address businesses, and potentially other business attributes. Next, a search request is received from a search 140. Preferably, the search request includes a geographic location and at least one search term, and it received over a computer network such as the World Wide Web. Profile pages are identified 141 that have keywords matching the keywords received from the searcher. Finally, the results are transmitted 144 to the searcher in two separate search results both readily available to the searcher.

Continuing with FIG. 1, the dual search results transmitted include a first results listing comprising profile pages having a physical address 145, and a second results listing comprising profile pages that are eCommerce 146. This reduces the extra search effort of the consumer as the consumer conducts his or her searches. In an exemplary embodiment, when the user searches for a business, the system will display the search results on 2 tab pages. The first and default tab displays traditional business results, i.e. brick and mortar. The second tab displays E-business results based on the search criteria. These two tabs are mutually exclusive for the business results. The E-business tab is displayed as nationwide results. Thus, the searcher can at any time switch between E-business or traditional business search results, simply by changing tabs.

In an alternative embodiment, the search results, whether of whether split into physical address results and eCommerce results, are ranked according to a unique ranking system. The exemplary embodiment described above involving tabs, this same ranking algorithm is utilized. Many factors may be involved in the ranking process, as described. Here, the order of ranking in the search results is largely dependent upon the degree of integration of the node within the network and the level of acceptance of the node by network as a whole. It is important to note there are no paid ranking positions. That is, higher rankings cannot be “purchased” through the network and instead must be organically and dynamically achieved

Continuing to refer to FIG. 1, but describing now an optional alternative embodiment, business attributes 138 are also a part of the profile page database. Although steps 140 and 141 appear again as they did in the description above, in this embodiment the search results 143 are influenced by and dependent on the business ranking score and ranking statistics 142. The ranking score is determined by the business attributes 138. In summary, various business attributes, i.e. activities by business user, contribute points towards a total points value assigned to the business. In a preferred embodiment the points value resets after a given amount of time. For instance, in an exemplary embodiment the points value resets to zero every 24 hours.

Continuing with this exemplary case, one factor influencing the points value assigned to the business profile is the average review score of the business profile, scaled as described above to a maximum of five. The more positive the reviews of a business profile, the more points that business would have, and the higher the business profile page would rank in the search results. Conversely, the lower the review score of a business profile, the less likely that business will rank higher in search results. As some other exemplary attributes that affect score, the more frequently a business user updates the business profile (both in total update and most recent update), the more likely that business will rank higher in search results. Conversely, the less frequently a business updates its profile (both in total update and most recent update), the less likely that business will rank higher in search results. The more frequently a business accesses its profile, the more likely that business will rank higher in search results. Conversely, the less frequently a business accesses its profile, the less likely that business will rank higher in search results.

Essentially, as evidenced above, the various activities and qualities described in relation to a business's profile page, affect the placement of the business profile page in a search conducted on the Applicant's system. Because this encourages participation in the network, the network is encouraged to grow as more users compete with one another to participate in the network to a larger extent.

In a preferred embodiment of the invention the algorithm underlying the business search sorts the results by points assigned to the various business profiles being sorted in the search results. Of course, before there are any businesses to sort, the search engine first matches keywords on each searched profile to keywords input by the searcher. This first step is well known in the art and will not be described further here.

Essentially, for all business profiles that match keywords to the keywords searched, a ranking determination will be made and all said businesses are displayed in order of rank. Preferably, points are assigned daily by an Update Profile Rankings module. Points are assigned based on activities of the business owners. In a most preferred embodiment of the invention, activities include but are not limited to updating a business owner profile, adding photos, adding a commercial, replying to a message, scheduling an appointment, adding an affiliate, having a high rating, and receiving many hits. In a preferred embodiment, points are accrued according to the following list of activities, and whether each activity occurred in the 24 hours preceding the daily update:

| Points | | |
|---|---|---|
| Awarded | | Event |
| 3 | points | Business owner updated profile that day |
| 1 | point | Business owner added photos that day |
| 1 | point | Business owner added a commercial that day |
| 0-5 | points | Business owner's average review, scaled to a maximum |
| | | 5 points |
| 1 | point | Business owner scheduled an appointment on a business |
| | | calendar |
| 1 | point | Business owner added an affiliate |
| 1 | point | Business owner added an associate |
| 2 | point | Business owner creates and sends a new coupon |
| 1 | point | Business profile page received a referral |

In addition to adding points as shown above, in a preferred embodiment points are deducted for various activities, such as for either deleting a photo or deleting a commercial from the business profile page. Hence, profile rank in a preferred embodiment is based on profile points accrued minus profile points deleted. In an alternative embodiment, a running points total may be calculated day after day by taking the previous day's total and adding to it the previous 24 hour's accrued points and subtracting the previous 24 hour's deductions. When a business user cancels the business user account with the Applicant's network, the profile rank is set to zero. Likewise, when a business user's account is placed on hold, there will be no daily updates to the ranking score, and the ranking score will stay the same from day to day.

The search results summary may include the following as well as other information: the business name, the business category, the business address, phone number, fax number, website link, directions link, a link to schedule an appointment with the business, a link to business profile page reviews, a link to send the business user's contact info, and an instant message link. Information not displayed in the search results is displayed once the business user link is clicked and the business user profile is viewed. Whether any of the above links are displayed to the user depends on whether the business is a participating business or a nonparticipating business, as defined next.

Participating businesses, i.e. businesses that have business user accounts with the Applicant's system have the option of turning on as many of the above search results to display as desired. Nonparticipating businesses, i.e. businesses automatically added based on data from 3^{rd} party sources, will display whatever information is pulled from the 3^{rd} party source or other public directory searched for inclusion by the Applicant's system in the search results. Search engines commonly import data from public directories, and any number of means for importing data is suitable for purposes of this application. For instance, if the telephone number and business name of a plumber is available in a public yellow pages listing, this information may be used in the search results.

Previews of profiles are also available for users of the system in an alternative embodiment of the invention. Here, on any page listing multiple business profile pages, the user may click on a “preview profile” hyperlink, and a popup window on the user's display shows details about the business profile page in clicked. Alternatively, certain details may appear as the user “hovers” the cursor over the link to the business profile page. Preferably, details about the business that will appear in a preview include business duration, entity type, number of employees, local memberships, the business mission statement, core values of the business, a description of the business, and a description of the products/services offered.

In the nascent stages of the applicant's system, before there are a large number of participating users, the search function may optionally return only businesses pulled from a public directory, or may as described above supplement the results of a user search with results taken from a public directory.

In addition to proving a search engine for a consumer to locate a business, the present system also provides a simple hierarchical directory. This directory facilitates a user who is uncertain as to what should be searched. When the user wishes to find a business when the user only knows the grouping of services or products that are needed, the user may choose the appropriate grouping or category. From there, subcategories allow the user to narrow down the precise service or product that is needed. For instance, under the main category restaurants there may be various subcategories corresponding to the different types of restaurants that are listed within the main category.

The system also provides for a help feature. Here, the user in a certain geographic area may post a public message that is available to all other users in that geographic area. All business user with profiles in the same geographic area as the consumer will receive the offer for contact, and may contact the consumer if they wish. The consumer can specify the method of contact desired. The consumer also has the option of narrowing down the distance that the request for help will propagate. For instance, in a busy city there may be hundreds (or thousands) of coffee shops, and the consumer may want one in the consumer's neighborhood, in this instance would limit the request for help to those within one mile. This means of interaction also allows consumer-to-consumer interaction. Here, a consumer can post for sale threads on a message board, and register certain key words associated with the sale. These keywords may be connected with the needs of a potential buyer who is in need of what the consumer is placing for sale and searches the message board for those keywords. A potential buyer can also post their needs on a message board in a similar fashion for searching buy a potential seller.

Most network services, including the network service disclosed herein, are web based hence provide a variety of ways for users to interact, including but not being limited to chat, messaging, e-mail, video, voice chat, file sharing, blogging, discussion groups, and so on. Once a business is located and chosen by a consumer, either through a search query as described above or through direct lookup via a simple search for the business name or other business attribute, the user may interact with the business user through any number of means commonly available for communication over a network, such as those described above.

In addition to the consumer and business users, a third type of account is the site administrator account. The administrator has additional rights beyond the other accounts that allow the administrator to take on a more managerial role within the Applicant's network. For instance, templates for users to use while making their profiles may be created, additions and deletions from the various drop down lists used by users creating profiles may be made, a word filter may be edited for application throughout the network, a payment module may be viewed and manipulated as needed, coupon templates may be made, and other similar administrative duties may be performed as is well known in the art.

The Administrator also manages the web presence of the network and has typical web site managing functions such as managing users (blocking, activating, suspending, deleting profiles and accounts), approving business owner profiles, managing content filters, managing business certification documents, approving business commercials before they are publicly posted, managing business links, profiles, advertisement links, generating reports and statistics etc. Generally, accounts would only be held, suspended, or removed for transactions or actions taken by the user or profile that are against network-allowed guidelines In a preferred embodiment, the site administrator will login through a different URL from the general business owner and consumer website URL. A username and password will first be required to ensure security is maintained.

The site administrator may broadcast messages or news to all participating nodes, or specifically to one of the classes of registered users. These messages or news postings will appear in the dashboard of those users able to receive it.

For each type of account, a help link is displayed to the user on the account dashboard. This is similar to a conventional help file to facilitate the user's understanding and navigation of the network. The help pages will be available for every page and function available to a user. A generic help page is also available, the generic help page comprising general help advice for using the site, tips, and a Frequently Asked Questions (FAQ) document. Tips of the Day will be displayed on the user's dashboard. They may be system wide, that is, consistent for all users for any given day, or they may be specific to the type of user or area of the user. In an alternative embodiment of the invention, the tip of the day may be sponsored by another user.

Security measures are taken across the network to ensure that all sensitive financial data on file is encrypted. Tables are password protected using SQL Server security. All passwords and user credit card information is encrypted. Secure Socket Layer (SSL) is implemented for business account features to provide additional security for that area. Users will have access to only the data they have been authorized to view. Preferably, role-based security will be implemented in the system, the roles being administrator, business owner, and consumer. Users who do not sign up with the network can access the public sections of the network without any authorization required. Communications between businesses and consumers will be monitored for fraud and potential harm to either party. This will generally be accomplished through content filters that search for language indicative of a scam, much in the same way spam filters block unwanted and potentially damaging e-mails.

With respect to the above description then, it is to be realized that material disclosed in the applicant's drawings and description may be modified in certain ways while still producing the same result claimed by the applicant. Such variations are deemed readily apparent and obvious to one skilled in the art, and all equivalent relationships to those illustrated in the drawings and equations and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of weighting the relative importance of a plurality of business profile pages in a database on a server computer comprising the steps of:
a. receiving at said server computer one or more keyword terms from said profile pages wherein at least one of said profile pages represents a business having a physical address and wherein at least one of said profile pages represents a business that is eCommerce;
b. generating at said server computer a profile page database including said one or more keyword terms and said physical address, wherein said one or more keyword terms corresponds to a profile page and wherein said physical address corresponds to a profile page representing a business having a physical address;
c. receiving a search request from a searcher, the search request including a geographic location and at least one search term, the search being received over the computer network from a remote computer;
d. identifying the profile pages within said profile page database having a keyword term generating a match with said at least one search term;
e. identifying the profile pages representing a business having a physical address that generate a match with said geographic location; and
f. transmitting dual search results in response to said search request, the dual search results including first results data comprising profile pages having a physical address and second results data comprising profile pages that are eCommerce only.

2. The method according to claim 1 further comprising:
a. receiving a plurality of business attributes associated with a profile page and storing said plurality of business attributes into said profile page database;
b. determining for a plurality of profile pages, a business ranking score for each said profile page, the business ranking score based on said business attributes;
c. generating ranking statistics based on said business ranking scores; and
d. wherein said first and second results data transmitted are arranged in an order dependent upon said ranking statistics.

3. The method of claim 2 further comprising:
a. an updating means comprising receiving an update request and in substantially real time upon receiving said request, updating said profile page; and
b. a messaging means comprising receiving a message directed to a profile page and sending a message originating from a profile page.

4. The method of claim 3 wherein said business attributes comprise at least three classes of attributes each being assigned a points value, and wherein said business ranking score is determined by the sum of said points values accrued over a period of time.

5. The method of claim 4 wherein said business attributes comprise:
a. data regarding the occurrence or nonoccurrence of receipt of said update request;
b. data regarding the occurrence or nonoccurrence of receipt of a request to add a photo to said profile page;
c. data regarding the occurrence or nonoccurrence of receipt of a request to add a commercial to said profile page;
d. an average review score for said profile page;
e. data regarding the occurrence or nonoccurrence of a request to add an affiliate to said profile page; and
f. data regarding the occurrence or nonoccurrence of a request to send a coupon.

6. The method of claim 5 wherein said business attributes further comprise:
a. data regarding the occurrence or nonoccurrence of receipt of a request to schedule an appointment on a calendar on said profile page;
b. data regarding the occurrence or nonoccurrence of receipt of a business referral; and
c. data regarding the occurrence or nonoccurrence of a request to add an associate to said profile page.

7. A method for providing searchable business information via a network based business and consumer resource system, wherein a means is provided to manipulate in real time a profile page's ranking in a search results listing, the method comprising:
a. receiving a plurality of business attributes and storing said plurality of business attributes into a profile page database, said business attributes being associated with a profile page, and wherein one of said attributes is a keyword term;
b. maintaining a business profile page database including a plurality of said profile pages;
c. determining for a plurality of profile pages, a business ranking score for each said profile page, the business ranking score based on said business attributes;
d. generating ranking statistics based on the business ranking scores;
e. receiving a search request over a network from a remote computer to search said profile database, the search request including at least one search term;
f. identifying the profile pages in said business profile database having a keyword term generating a match with said search term; and
g. providing ranked search results in response to the search requests, the ranked search results comprising a plurality of profile pages arranged in an order determined by said ranking statistics.

8. The method of claim 7 wherein said ranked search results are transmitted as a first data set comprising profile pages having a physical address and a second data set comprising profile pages that are eCommerce only.

9. The method of claim 7 further comprising:
a. an updating means comprising receiving an update request and in substantially real time upon receiving said request, updating said profile page; and
b. a messaging means comprising receiving a message directed to a profile page and sending a message originating from a profile page.

10. The method of claim 9 wherein said business attributes comprise at least three classes of attributes and wherein each said class is assigned a points value, and wherein said business ranking score is determined by the sum of said points values accrued over a period of time.

11. The method of claim 10 wherein said business attributes comprise:
a. data regarding the occurrence or nonoccurrence of receipt of said update request;
b. data regarding the occurrence or nonoccurrence of receipt of a request to add a photo to said profile page;
c. data regarding the occurrence or nonoccurrence of receipt of a request to add a commercial to said profile page;
d. an average review score for said profile page;
e. data regarding the occurrence or nonoccurrence of a request to add an affiliate to said profile page; and
f. data regarding the occurrence or nonoccurrence of a request to send a coupon.

12. The method of claim 11 wherein said business attributes further comprise:
a. data regarding the occurrence or nonoccurrence of receipt of a request to schedule an appointment on a calendar on said profile page;
b. data regarding the occurrence or nonoccurrence of receipt of a business referral; and
c. data regarding the occurrence or nonoccurrence of a request to add an associate to said profile page.

13. A method of link swapping to improve the ranking of a business profile page in an Internet search engine, the method comprising:
a. providing a database of profile pages comprising a first and second business profile page, the first business profile page comprising a first search term for access by an Internet search engine web crawler and the second business profile page comprising a second search term for access by said crawler;
b. linking said second business profile page to said first business profile page such that said first profile page search term is accessible by said crawler as said crawler accesses said second page and wherein said second profile page search term is accessible by said crawler as said crawler accesses said first page.

14. The method according to claim 13 wherein said first profile page search term is located in a subfolder of said second profile page and wherein said second profile page search term is located in a subfolder of said first profile page.

15. The method according to claim 13 further comprising:
a. receiving a plurality of requests to modify said first profile page and wherein said modifications affect said first profile page search term available to said second profile page; and
b. receiving a plurality of requests to modify said second profile page and wherein said modifications affect said second profile page search term available to said first profile page.

16. The method according to claim 13 further comprising:
a. providing a third business profile page comprising a third search term for access by said crawler; and
b. linking said first business profile page to said second and third business profile pages such that said first profile page search term is accessible by said crawler as said crawler accesses said second and third business profile pages, linking said second business profile page to said first and third business profile pages such that said second profile page search term is accessible by said crawler as said crawler accesses said first and third business profile pages; and linking said third business profile page to said first and second business profile pages such that said third profile page search term is accessible by said crawler as said crawler accesses said first and second business profile pages.

17. The method according to claim 16 wherein said first profile page search term is located in a subfolder of said second and third profile pages, wherein said second profile page search term is located in a subfolder of said first and third profile pages, and wherein said third profile page search term is located in a subfolder of said first and second profile pages.

18. A method for performing targeting marketing by sending a multimedia message to a remote computer over a network using high volume electronic messaging, the method comprising:
a. a generating means for generating a list of multimedia messages for delivery to a plurality of remote computers, wherein each remote computer is associated with a consumer;
b. compiling consumer data including attributes associated with each said consumer;
c. a grouping means for grouping a subset of said consumers based on said consumer data and associating said subset of consumers with a multimedia message selected from said list of multimedia messages;
d. a calculating means for calculating sending information representing a rate of multimedia messages sent per period time to a plurality of sub-subsets of said subset of consumers; and
e. transmitting during a given time period said selected multimedia message to various sub-subsets of said consumers according to said sending information until said multimedia message has been transmitted to all of said subset of consumers.

19. The method according to claim 18 further comprising:
a. an input means for receiving a transmission maximum representing a maximum number of multimedia messages transmitted over a given time period; and
b. wherein the number of multimedia messages transmitted over a given time period does not exceed said transmission maximum.

20. The method according to claim 18 wherein each consumer in said subset of consumers shares at least one attribute.

21. The method according to claim 20 wherein each consumer has an associated consumer profile page, and wherein said compiled customer list information further includes current contact information associated with said consumer profile page.

22. The method according to claim 21 further comprising:
a. an input means for receiving a transmission maximum representing a maximum number of multimedia messages transmitted over a given time period; and
b. wherein the number of multimedia messages transmitted over a given time period does not exceed said transmission maximum.
